(19) United States
(12) Patent Application Publication
(10) Pub. No.: US 2022/0324351 A1
(43) Pub. Date: Oct. 13, 2022

(54) METHOD AND DEVICE FOR ADJUSTING THE TEMPERATURE OF A VEHICLE PART OF A MOTOR VEHICLE WITH AN ELECTRICAL ENERGY STORE

(71) Applicant: Robert Bosch GmbH, Stuttgart (DE)

(72) Inventors: Lucero Florez Ibanez, Stuttgart (DE); Anne Schieferstein, Wetzlar (DE); Claudia Gutekunst, Wolfschlugen (DE); Denis Selenin, Ebsdorfergrund (DE); Falk-Tillmann Koertel, Bad Hersfeld (DE); Jennifer Schneider, Reutlingen (DE); Joerg Heyse, Besigheim (DE); Matthias Rauscher, Ulm (DE); Milos Medvecky, Asperg (DE); Norma Raupach, Treuenbrietzen (DE); Patrik Schoen, Lollar (DE); Ran An, Moeglingen (DE); Rodrigo Dias Panza, Le Bouscat (FR); Theresa Jaksch, Hessigheim (DE)

(21) Appl. No.: 17/714,326

(22) Filed: Apr. 6, 2022

(30) Foreign Application Priority Data
Apr. 7, 2021 (DE) 10 2021 203 413.6

(51) Int. Cl. B60L 58/24; B60H 1/00

(52) U.S. Cl. CPC B60L 58/24; B60H 1/0073

(57) ABSTRACT

Operating a motor vehicle (1) by adjusting the temperature of one or more vehicle parts (3, 4). One method includes specifying (S2) an indication of an expected beginning-of-driving time (FBZ) of the motor vehicle (1) and a desired operating temperature (BT) of the one or more vehicle parts (3, 4); and waking up (S6) a controller (22), which is configured to control adjustment of the temperature of the respective vehicle part (3, 4), at a temperature-adjustment starting time (A2) which is chosen such that, if heating up or cooling down begins at the temperature-adjustment starting time (A2), the heating up or cooling down ends, by reaching the desired operating temperature (BT) of the corresponding vehicle part (3, 4), at a time which corresponds to the expected beginning-of-driving time (FBZ) or is just before the expected beginning-of-driving time (FBZ).

### BACKGROUND OF THE INVENTION

The invention relates to motor vehicles with an electrical energy store as an energy source, and in particular to methods for adjusting the temperature, i.e. for heating up or cooling down, a vehicle part, in particular a vehicle battery or the interior of a vehicle cabin.

Electrically operated motor vehicles generally have an electrical energy store, in particular in the form of a traction battery or a fuel cell. For providing the full capability of the electrical energy store, an operating temperature which generally lies well above an ambient temperature is necessary. At the beginning of driving, it is consequently often advisable to heat up the energy store in advance to an operating temperature or a beginning-of-driving temperature, in order in this way on the one hand to provide the full capability of the vehicle battery and on the other hand to avoid excessive loading of the energy store.

In other cases, in particular when operating the electrically operated motor vehicle at low outside temperatures, it is desirable that the interior of the vehicle cabin is heated up at the beginning of driving, in order to provide a comfortable driving atmosphere for the driver already at the beginning of driving.

Heating energy for heating up the corresponding vehicle part, such as for example the electrical energy store or the interior of the vehicle cabin, is generally drawn from the electrical energy store.

The document DE 10 2005 022 204 B1 discloses a method for heating up a battery in a vehicle with a battery heater, wherein a key-off state is determined and an energy flow from the battery to the heater is enabled after determining the key-off state. An energy flow from the battery to the heater is enabled by a controller, which is put into a sleep mode before it enables the energy flow from the battery to the heater if the key-off state has been determined. Furthermore, the controller is put into an active mode so as to enable the energy flow from the battery to the heater for heating up the battery.

The document DE 10 2014 204 260 A1 discloses a method for controlling an electric vehicle which is connected to an external power source. The method comprises charging a traction battery to a desired state of charge and conditioning the battery to a desired battery temperature according to a charge profile, which is based on a user-initiated request for vehicle conditioning.

### SUMMARY OF THE INVENTION

According to the invention, a method for operating a motor vehicle by adjusting the temperature of at least one vehicle part before the beginning of driving and a corresponding device and a motor vehicle are provided.

Further refinements are specified in the dependent claims.

According to a first aspect, a method for operating a motor vehicle by adjusting the temperature of one or more vehicle parts, in particular a vehicle battery and/or a fuel cell and/or an interior of a vehicle cabin, is provided, comprising the following steps:

specifying an indication of an expected beginning-of-driving time of the motor vehicle and a desired operating temperature of the one or more vehicle parts;

waking up a controller, which is configured to control adjustment of the temperature of the respective vehicle part, at a temperature-adjustment starting time which is chosen such that, if heating up or cooling down begins at the temperature-adjustment starting time, the heating up or cooling down ends, by reaching the desired operating temperature of the corresponding vehicle part, at a time which corresponds to the beginning-of-driving time or is just before the beginning-of-driving time.

The temperature of a vehicle part may be adjusted before beginning driving for example for reasons of the power to be provided for this, the efficiency to be provided or for reasons of comfort. Since, in particular if the electrical energy for adjusting the temperature of the vehicle part is drawn from the vehicle battery, the temperature-adjusting process, i.e. a heating-up process or a cooling-down process, is intended to be carried out as energy-efficiently as possible, phases in which a temperature of the vehicle part must be kept constant for a relatively long period of time with respect to a temperature difference in relation to the surroundings of the vehicle should be avoided. For this purpose, it is envisaged to carry out the heating up/cooling down of the vehicle part in such a way that the temperature-adjusting process ends just before the expected beginning-of-driving time. It can in this way be avoided that, after the end of the heating up or cooling down, the temperature of the vehicle part must be maintained over a relatively long time period, involving a high expenditure of energy.

It is provided that, after switching off the motor vehicle, a waking-up time of the waking up of the controller is determined. The waking-up time of the waking up of the controller is preferably chosen such that an adjustment of the temperature to the operating temperature can be achieved in every case, even when the vehicle part is at a temperature which corresponds to an ambient temperature of the motor vehicle predicted at the waking-up time.

In particular, at the waking-up time, the variation of the temperature of the vehicle part after the waking-up time may be determined while taking into account a temperature equalization curve (cooling-down curve or heating-up curve up to a temperature-adjustment starting time and heating-up curve or cooling-down curve up to the beginning-of-driving time) on the basis of the temperature of the vehicle part at the waking-up time of the waking up of the controller, the ambient temperature during the waking-up time, a heat transfer coefficient between the vehicle part and the surroundings and a thermal mass of the vehicle part and on the basis of temperature-adjustment parameters, in particular a provided heating or cooling power and other thermal energy sources. In this case, the temperature-adjustment starting time is chosen such that the desired operating temperature of the vehicle part is reached at the expected beginning-of-driving time.

At the waking-up time, a temperature-adjustment starting time at which the heating up/cooling down is intended to be begun is correspondingly determined from the temperature equalization curve.

Then the controller is returned to the standby mode and is woken up again at the temperature-adjustment starting time in order to start the temperature-adjusting process. As a result, it is possible to start the heating-up process/cooling-down process in such a way that the corresponding vehicle part has reached the desired operating temperature exactly at or just before the beginning-of-driving time.

Furthermore, it may be provided that, when the operating temperature has been reached, or the expected beginning-of-driving time has been reached, the temperature-adjusting process of the vehicle part is stopped. This applies in particular to vehicle parts of which the thermal mass is high and in the case of which a cooling-down process only takes place slowly. This is the case for example with vehicle batteries.

In the case of vehicle parts with lower thermal mass, such as for example the interior of a vehicle cabin, it can continue to be heated or cooled after reaching the desired operating temperature, in particular for a predetermined time period, if driving has not yet begun at the expected beginning-of-driving time and/or until driving has begun.

Furthermore, the temperature-adjustment starting time may be determined at a first waking-up time of the controller, which corresponds to a time of a predetermined time period before the beginning-of-driving time.

It may be provided that the controller is put into a standby mode after determining the temperature-adjustment starting time.

Furthermore, with the aid of a timer unit, the controller may be activated at the temperature-adjustment starting time as a second waking-up time, in order to start cooling down or heating up of the one or more vehicle parts.

According to one embodiment, the controller may determine the temperature-adjustment starting time by a temperature equalization curve being modeled by iteration, so that a cooling-down curve or heating-up curve up to the temperature-adjustment starting time and a heating-up curve or cooling-down curve from the temperature-adjustment starting time up to the beginning-of-driving time follow such a variation that the desired operating temperature is reached at the beginning-of-driving time, wherein the temperature equalization curve is modeled dependent on a thermal mass of the vehicle part concerned, a heat transfer coefficient between the vehicle part concerned and the surroundings, the temperature of the vehicle part at the temperature-adjustment starting time and the desired operating temperature.

Furthermore, after reaching the expected beginning-of-driving time, the desired operating temperature may be maintained for a predetermined time period, in particular dependent on a thermal mass of the vehicle part concerned.

In the case of multiple vehicle parts, different temperature-adjustment starting times may be determined.

It may be provided that the expected beginning-of-driving time is specified by a user or is received from a mobile device or is specified by a usage model, which is configured to model usage behavior in such a way that, dependent on the current time, a next beginning-of-driving time is indicated.

According to a further aspect, a device for operating a motor vehicle by adjusting the temperature of one or more vehicle parts, in particular a vehicle battery and/or an interior of a vehicle cabin, is provided, wherein the device is configured for:

specifying an indication of an expected beginning-of-driving time of the motor vehicle and a desired operating temperature of the one or more vehicle parts;

waking up a controller, which is configured to control adjustment of the temperature of the respective vehicle part, at a temperature-adjustment starting time which is chosen such that, if heating up or cooling down begins at the temperature-adjustment starting time, the heating up or cooling down ends, by reaching the desired operating temperature of the corresponding vehicle part, at a time which corresponds to the beginning-of-driving time or is just before the beginning-of-driving time.

### BRIEF DESCRIPTION OF THE DRAWINGS

Embodiments are explained in more detail below on the basis of the accompanying drawings, in which:

FIG. 1 shows a schematic representation of a vehicle with a vehicle battery, in particular for providing electrical energy for a traction drive of the vehicle;

FIG. 2 shows a flow diagram for illustrating a method for operating the temperature-adjusting system in a motor vehicle; and

FIG. 3 shows a representation of a cooling-down and heating-up curve for a vehicle part.

### DETAILED DESCRIPTION

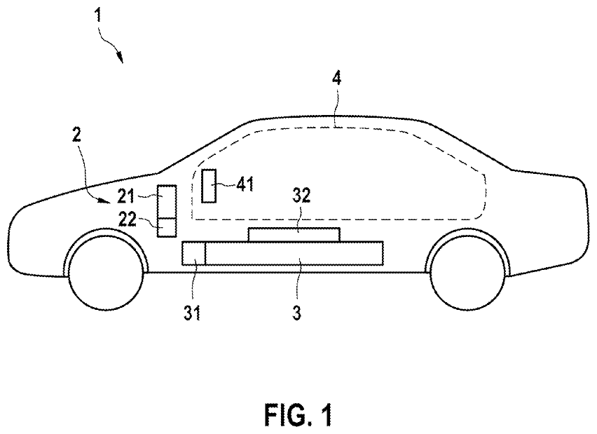

FIG. 1 shows a schematic representation of a motor vehicle 1 with a temperature-adjusting device 2 for a vehicle part. The vehicle part may be for example a vehicle battery 3 and/or an interior of a vehicle cabin 4 comprising interior surfaces and interior air of a vehicle cabin. Other vehicle parts may for example comprise a heatable steering wheel, a heatable vehicle seat, a fuel cell unit or the like.

The vehicle battery 3 may be provided with a battery management system 31, which apart from usual functions may also provide a temperature control of the vehicle battery 3 by means of a heating and/or cooling device 32. The heating and/or cooling device 32 is arranged on the vehicle battery 3 in such a way that the vehicle battery 3 can be heated by providing heating power or be cooled by providing cooling power.

By analogy, the vehicle cabin may be provided with a climate controller 41, such that a temperature control of the interior of the vehicle cabin 4 can be carried out with the aid of a heating and/or cooling device 42.

The heating and/or cooling devices 32, 42 may be supplied with electrical energy by way of the vehicle battery 3 or by way of an external energy source.

Both the battery management system 31 and the climate controller 41 can start and end a heating and/or cooling process of the vehicle battery 3 or of the interior of the vehicle cabin 4 in a way corresponding to an external specification.

The temperature-adjusting device 2 comprises a control unit 21 and a timer unit 22. The control unit 21 serves for carrying out calculations and for starting and ending heating or cooling processes in heatable or coolable vehicle parts (for example a vehicle battery or interior of a vehicle cabin). The control unit 21 can also be put in a standby mode, in which it has a low energy consumption. The standby mode of the control unit 21 may be ended by a corresponding wake-up signal.

The timer unit 22 merely serves the purpose of storing a waking-up time and waking up or activating a control unit 21 on standby at the waking-up time.

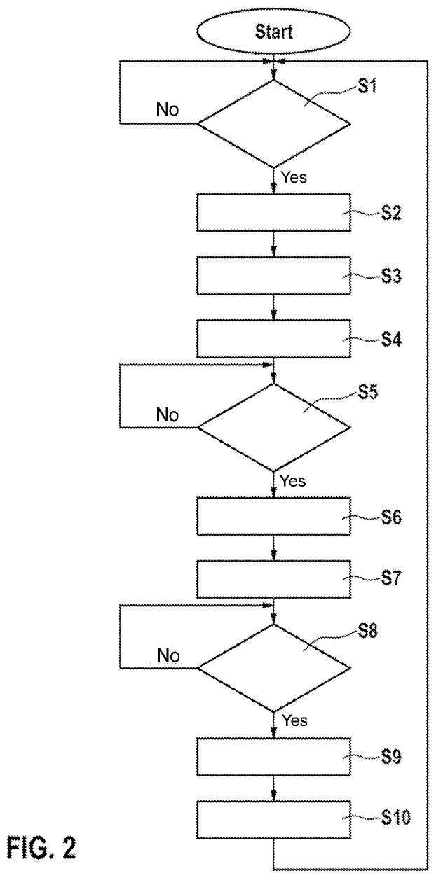

The temperature-adjusting system comprises the heating and/or cooling device 32, 42, the control unit 21 and the timer unit 22. The temperature-adjusting system is configured to perform the method illustrated by the flow diagram of FIG. 2. For the sake of simplicity, the method for adjusting the temperature of a vehicle part 3, 4 is described below on the basis of a heating-up process of the vehicle battery 3 and the interior of the vehicle cabin 4 respectively to a specified desired operating temperature which is greater than the ambient temperature. The method can also be applied analogously to cooling down of vehicle parts 3, 4.

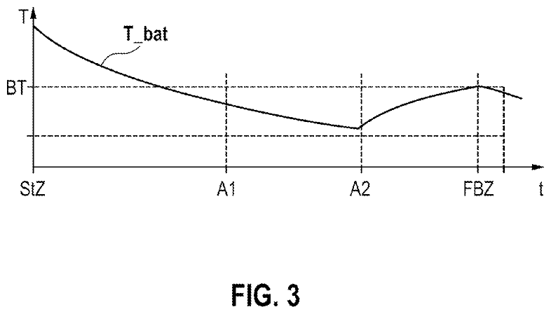

The method is also described with reference to the diagram of FIG. 3 which represents a temperature variation curve over time t that is given by way of example.

In step S1 it is checked whether the vehicle has been switched off. The switching off of the vehicle generally takes place after ending driving and by getting out and locking the motor vehicle. If it is determined that the vehicle has been switched off (alternative: yes), the method is continued with step S2. Otherwise (alternative: no), it returns to step S1.

At the switching-off time StZ, i.e. the time of switching off the motor vehicle, a beginning-of-driving time FBZ, i.e. the time of expected beginning of driving, is determined in step S2. This beginning-of-driving time FBZ may be specified or retrieved in a suitable way as information from an external source, such as for example a mobile device or a database. In particular, the expected beginning-of-driving time FBZ may be taken from a diary of the driver or user. Alternatively known are mathematical usage models, which can depict the usage behavior of a vehicle over time driver-individually and, by means of making an inquiry, can indicate a diary entry of the time of the next beginning of driving. The usage models can be trained in a data-based manner with the aid of machine learning methods. For example, in the case of regular driving to work and back during weekdays, the times for beginning driving can be assumed, for example as 8 o'clock in the morning or 5 o'clock in the evening on weekdays.

In step S3, a first waking-up time A1, which is for example between 2 and 6 hours, in particular 4 hours, before the expected beginning-of-driving time FBZ, is determined, in particular in the control unit 22. In particular, this specified time period may be chosen such that it is sufficiently great that heating up to the respective desired operating temperature can be achieved from any possible temperature of the vehicle part at the first waking-up time A1, in particular the temperature of the vehicle battery 3 or of the interior of the vehicle cabin 4.

In the case of vehicle parts, such as for example the vehicle battery 3, the operating temperature BT is fixed and component-immanent, whereas in the case of the interior of the vehicle cabin the operating temperature can be individually specified by the driver, optionally by way of an operator control unit in the vehicle or by way of a mobile device, which may be in connection with the control unit 21 of the vehicle.

In step S4, this first waking-up time is transmitted to the timer unit 22 and puts the control unit 21 in a standby mode.

Subsequently, in step S5, it is checked in the timer unit 22 whether the first waking-up time has been reached. If this is the case (alternative: yes), the method is continued with step S6, otherwise (alternative: no) it returns to step S5.

In step S6, the control unit 22 is woken up, after which the control unit 22 determines a second waking-up time A2 as the temperature-adjustment starting time at which the heating-up process (temperature-adjusting process of the vehicle part) is intended to be started. This second waking-up time A2 is determined dependent on a cooling-down curve of the vehicle part 3, 4 concerned on the basis of the first waking-up time A1 and a heating-up curve on the basis of the second waking-up time A2 to be determined, so that the heating up of the vehicle part 3, 4 to the operating temperature BT ends exactly at the expected beginning-of-driving time FBZ, i.e. more than 0-5 minutes before the expected beginning-of-driving time FBZ.

The cooling-down curve and the heating-up curve are determined on the basis of an ambient temperature, a thermal mass of the vehicle part concerned or the respective vehicle part, a heat transfer coefficient between the vehicle part 3, 4 and the surroundings and the available heating power (temperature-adjusting power, i.e. heating or cooling power) in a way known per se. In particular, the second waking-up time A2 may be determined by iteration between the first waking-up time A1 and the expected beginning-of-driving time, wherein the respective temperature swing is obtained dependent on the cooling-down and heating-up curves.

Determining the second waking-up time A2 in this way makes it possible that no or only little additional electrical energy is consumed to keep the temperature of the vehicle part 3, 4 concerned at the desired operating temperature if the actual beginning of driving corresponds to the expected beginning-of-driving time.

The determination of the second waking-up time A2 may also take place on the basis of the available electrical energy. If the electrical energy is drawn from the vehicle battery 3, carrying out the heating-up process may also be made dependent on the state of charge. If the state of charge goes below a specified threshold value, the carrying out of the heating-up process may be interrupted, and no second waking-up time A2 is established. It is also possible for different second waking-up times A2 to be determined for the vehicle battery 3 and the interior of the vehicle cabin 4. When there is a low state of charge of the vehicle battery 3, it is also possible for only the heating up of the vehicle battery 3 to be carried out, whereas the interior of the vehicle cabin is not heated before the beginning of driving.

In the determination of the cooling-down curve and the heating-up curve, the ambient temperature may be taken into account. In particular, dependent on the weather of a geographical position of the vehicle, weather information which takes into account changes in the ambient temperature of the vehicle may be retrieved, so that an earlier second waking-up time A2 is obtained when there is a falling ambient temperature than when there is a rising ambient temperature.

After determining the second waking-up time A2, in step S7 the second waking-up time A2 is transmitted to the timer unit 22 and the controller 21 is returned to the standby mode.

In step S8, it is checked by the timer unit 22 whether the second waking-up time A2 has been reached. If this is the case (alternative: yes), the method is continued with step S9, otherwise (alternative: no), it returns to step S8.

In step S9, the heating-up process of the vehicle part, i.e. the vehicle battery and/or the interior of the vehicle cabin 4, is started. For carrying out the heating-up process, the controller 21 remains active and activates the heating and/or cooling device 32, 42 by way of the temperature management system 31 or the climate controller 41 for carrying out the heating process. In this case, it is continuously checked whether the operating temperature BT has been reached.

Depending on the type of vehicle part 3, 4, after reaching the operating temperature BT the heating up is ended in step S10, in particular if the thermal mass of the heated vehicle part 3, 4 is very high, so that cooling down after the expected beginning-of-driving time (when the beginning of driving is delayed) would only take place slowly on account of a lower ambient temperature. This may be the case for example with a vehicle battery 3.

Alternatively, for vehicle parts which have a lower thermal mass, such as for example the interior of the vehicle cabin, it may likewise be envisaged to maintain the operating temperature for a predetermined time period after it is reached if the beginning of driving does not take place just after reaching the operating temperature.

The above method, described by way of example, can also be used in an analogous way for setting operating temperatures which are lower than the ambient temperature. Thus, for example, an interior vehicle cabin temperature which lies well above the set operating temperature BT on account of a high ambient temperature may be determined at the first waking-up time A1. In an analogous way, while taking into account the electrical energy available, a cooling power, a thermal mass and a heat transfer coefficient, the second waking-up time A2 may be determined in such a way that the cooling down of the interior of the vehicle cabin 4 can be performed up to the expected beginning-of-driving time.

1. A method for operating a motor vehicle (1) by adjusting the temperature of one or more vehicle parts (3, 4), the method comprising the following steps:
specifying (S2) an indication of an expected beginning-of-driving time (FBZ) of the motor vehicle (1) and a desired operating temperature (BT) of the one or more vehicle parts (3, 4);
waking up (S6) a controller (22), which is configured to control adjustment of the temperature of the respective vehicle part (3, 4), at a temperature-adjustment starting time (A2) which is chosen such that, if heating up or cooling down begins at the temperature-adjustment starting time (A2), the heating up or cooling down ends, by reaching the desired operating temperature (BT) of the corresponding vehicle part (3, 4), at a time which corresponds to the expected beginning-of-driving time (FBZ) or is just before the expected beginning-of-driving time (FBZ).

2. The method according to claim 1, wherein the temperature-adjustment starting time (A2) is determined at a first waking-up time of the controller (22) which corresponds to a time of a predetermined time period before the beginning-of-driving time.

3. The method according to claim 2, wherein the controller (22) is put into a standby mode after determining the temperature-adjustment starting time.

4. The method according to claim 3, wherein, with the aid of a timer unit (21), the controller (22) is activated at the temperature-adjustment starting time (A2) as a second waking-up time, in order to start cooling down or heating up of the one or more vehicle parts (3, 4).

5. The method according to claim 1, wherein the controller (22) determines the temperature-adjustment starting time by a temperature equalization curve being modeled by iteration, so that a cooling-down curve or heating-up curve up to the temperature-adjustment starting time (A2) and a heating-up curve or cooling-down curve from the temperature-adjustment starting time up to the beginning-of-driving time follow such a variation that the desired operating temperature (BT) is reached at the beginning-of-driving time (FBZ), wherein the temperature equalization curve is modeled dependent on a thermal mass of the vehicle part (3, 4) concerned, a heat transfer coefficient between the vehicle part (3, 4) concerned and the surroundings, the temperature of the vehicle part (3, 4) at the temperature-adjustment starting time and the desired operating temperature (BT).

6. The method according to claim 1, wherein, after reaching the expected beginning-of-driving time (FBZ), the desired operating temperature (BT) is maintained for a predetermined time period, dependent on a thermal mass of the vehicle part (3, 4) concerned.

7. The method according to claim 1, wherein, in the case of multiple vehicle parts (3, 4), different temperature-adjustment starting times (A2) are determined.

8. The method according to claim 1, wherein the expected beginning-of-driving time (FBZ) is specified by a user or is received from a mobile device or is specified by a usage model, which is configured to model usage behavior in such a way that, dependent on the current time, a next beginning-of-driving time (FBZ) is indicated.

9. A device for operating a motor vehicle by adjusting the temperature of one or more vehicle parts (3, 4), wherein the device is configured to:
specify an indication of an expected beginning-of-driving time (FBZ) of the motor vehicle and a desired operating temperature (BT) of the one or more vehicle parts (3, 4);
wake up a controller (22), which is configured to control adjustment of the temperature of the respective vehicle part (3, 4), at a temperature-adjustment starting time which is chosen such that, if heating up or cooling down begins at the temperature-adjustment starting time (A2), the heating up or cooling down ends, by reaching the desired operating temperature of the corresponding vehicle part (3, 4), at a time which corresponds to the expected beginning-of-driving time (FBZ) or is just before the expected beginning-of-driving time (FBZ).

10. A non-transitory, computer-readable storage medium, comprising commands that when executed by a computer cause the computer to
specify an indication of an expected beginning-of-driving time (FBZ) of a motor vehicle and a desired operating temperature (BT) of one or more vehicle parts (3, 4);
wake up a controller (22), which is configured to control adjustment of the temperature of the respective vehicle part (3, 4), at a temperature-adjustment starting time which is chosen such that, if heating up or cooling down begins at the temperature-adjustment starting time (A2), the heating up or cooling down ends, by reaching the desired operating temperature of the corresponding vehicle part (3, 4), at a time which corresponds to the expected beginning-of-driving time (FBZ) or is just before the expected beginning-of-driving time (FBZ).
